(19) United States
(12) Patent Application Publication
(10) Pub. No.: US 2024/0178562 A1
(43) Pub. Date: May 30, 2024

(54) NON-POWERED ELEMENT

(71) Applicant: Pacific Industrial Co., Ltd., Gifu-ken (JP)

(72) Inventor: Yasuhisa Tsujita, Motosu-shi (JP)

(73) Assignee: Pacific Industrial Co., Ltd., Gifu-ken (JP)

(21) Appl. No.: 18/282,134

(22) PCT Filed: Sep. 6, 2021
(86) PCT No.: PCT/JP2021/032610

§ 371 Date: Sep. 14, 2023

(51) Int. Cl. H01Q 5/378; H01Q 1/24; H01Q 1/42; H01Q 7/00

(52) U.S. Cl. CPC H01Q 5/378; H01Q 1/24; H01Q 1/42; H01Q 7/00

(57) ABSTRACT

A parasitic element is used in a transmitter configured to transmit data. The transmitter includes a loop antenna to which power is supplied and a housing that accommodates the loop antenna. The parasitic element is disposed to be located outside the housing. The parasitic element includes a loop portion that is a part of the parasitic element, and an extended section that is a part other than the loop portion. The loop portion is electromagnetically coupled to the loop antenna. The extended section includes a first end of the parasitic element as an open end.

### TECHNICAL FIELD

The present disclosure relates to a parasitic element used in a transmitter.

### BACKGROUND ART

A transmitter configured to transmit data includes a transmission antenna for transmitting the data. Patent Literature 1 discloses that an antenna device serving as a transmission antenna is incorporated in a case of a portable device serving as a transmitter. The portable device of Patent Literature 1 is a transmitter used in a keyless system of a vehicle.

### CITATION LIST

### Patent Literature

Patent Literature 1: Japanese Laid-Open Patent Publication No. 2015-35644

### SUMMARY OF INVENTION

### Technical Problem

In some cases, the portable device disclosed in Patent Literature 1 is used as a transmitter in another system. In other words, an existing transmitter may be used for other purposes. In such a case, when the transmission output of the transmitter is insufficient, it is desirable to increase the transmission output without changing the hardware including the transmission antenna of the transmitter or adding a device requiring a power supply.

### Solution to Problem

In one aspect of the present disclosure, a parasitic element for use in a transmitter is configured to transmit data. The transmitter includes a loop antenna to which power is supplied and a housing that accommodates the loop antenna. The parasitic element is disposed to be located outside the housing and includes a loop portion that is a part of the parasitic element and an extended section that is a part other than the loop portion and extends from the loop portion. The loop portion is configured to be electromagnetically coupled to the loop antenna. The extended section includes at least one end of the parasitic element as an open end.

With this configuration, when transmission power is supplied to the loop antenna of the transmitter, a magnetic field and an electric field are generated around the loop antenna, so that energy is radiated from the loop antenna. Outside the housing, an induced current flows through the loop portion, which is coupled to the magnetic field of the loop antenna. As compared to a comparative example in which an element disposed outside a housing is formed in a linear shape, an induced current larger than that in the comparative example flows through the loop portion.

A potential difference is created between the vicinity of the open end of the extended section and other portions in the parasitic element through which the induced current flows. This generates an electric field also in the extended section. As a result, the energy received from the loop antenna is efficiently radiated as radio waves by using the extended section. This increases the transmission output from the transmitter as compared with a case in which energy is radiated as radio waves from a single loop antenna of the transmitter. If the transmission power to the loop antenna is the same, the communication distance from the transmitter can be extended. Therefore, even in a case of an existing transmitter, the transmission output of the transmitter can be increased only by adding the parasitic element to the outside of the housing, without changing the hardware including the loop antenna of the transmitter and without adding a device requiring a power supply.

In the above-described parasitic element, the extended section may be one, and the open end may be one. The parasitic element may include a first end that is the open end and a second end configured to be connected to a ground.

In the above-described parasitic element, the extended section may haves a length of 0.10λ to 0.40λ, where λ is a wavelength at an operating frequency of the loop antenna.

In the above-described parasitic element, the extended section may include two extended sections located on opposite sides of the loop portion, and each of the two extended sections includes the open end.

In the above-described parasitic element, the two extended sections may have a length of 0.19λ to 0.25λ, where λ is a wavelength at an operating frequency of the loop antenna.

The above-described parasitic element may include a linear element arranged side by side with the extended section.

### BRIEF DESCRIPTION OF DRAWINGS

FIG. 1 is a perspective view of a transmitter and a parasitic element according to a first embodiment.

FIG. 2 is an end view of the interior of the transmitter shown in FIG. 1 and a parasitic element.

FIG. 3 is an exploded perspective view of the transmitter shown in FIG. 1.

FIG. 4 is a front view of the parasitic element and the transmitter of FIG. 1.

FIG. 5 is a graph showing a relationship between a length and a gain of an extended section of the parasitic element shown in FIG. 1.

FIG. 6 is a perspective view of a transmitter and a parasitic element according to a second embodiment.

FIG. 7 is a front view of the parasitic element shown in FIG. 6.

FIG. 8 is a graph showing a relationship between a length and a gain of an extended section of the parasitic element shown in FIG. 7.

FIG. 9 is a perspective view of a parasitic element according to a modification of the first embodiment.

FIG. 10 is a perspective view of a parasitic element according to another modification of the first embodiment.

FIG. 11 is a perspective view of a parasitic element according to a modification, including a linear element.

### DESCRIPTION OF EMBODIMENTS

### First Embodiment

A parasitic element according to a first embodiment will be described.

### Transmitter

A transmitter has, for example, substantially the same configuration as the transmitter of a tire condition monitoring apparatus. In other words, the transmitter is an existing transmitter. Although not illustrated, the tire condition monitoring apparatus includes transmitters and a receiver. Each transmitter is attached to one of the four wheel assemblies. The receiver is installed in the vehicle. Each transmitter is attached to the wheel or the tire of the corresponding wheel assembly. The transmitter is disposed in the internal space of the tire.

The transmitter includes a housing, a tire condition detecting unit, a substrate, a transmission circuit, and a loop antenna. The housing accommodates the tire condition detecting unit, the substrate, the transmission circuit, and the loop antenna. The transmitter wirelessly uses the transmission circuit and the loop antenna to transmit a data signal including information of the tire detected by the tire condition detecting unit to the receiver. The tire condition monitoring apparatus monitors the condition of the tire by receiving the data signal transmitted from the transmitter at the receiver.

The transmitter of the tire condition monitoring apparatus has a high environmental resistance so as to withstand the environment in the tire such as moisture and corrosive gas in the tire. In order to provide a high environmental resistance, the housing of the transmitter has a sealed structure. In addition, since the transmitter is attached to the wheel or the tire, which always receives a centrifugal force during traveling of the vehicle, the transmitter is reduced in size and weight. In order to reduce the size and weight of the transmitter, the housing is reduced in size, and the loop antenna is also reduced in size.

Thus, there is a demand for compact transmitters with a sealed structure that can also be used outdoors, for example, as a transmitter in a road surface temperature measuring system.

The road surface temperature measuring system includes at least one temperature measuring device including a transmitter and at least one receiver. The at least one temperature measuring device is located on the outdoor road. The temperature measuring device measures the temperature of the road and wirelessly transmits the measured temperature as a data signal from the transmitter to the receiver. The transmitter used in the road surface temperature measuring system includes a temperature sensor instead of a tire condition detecting unit. Hereinafter, a parasitic element used in a transmitter of a road surface temperature measuring system will be described.

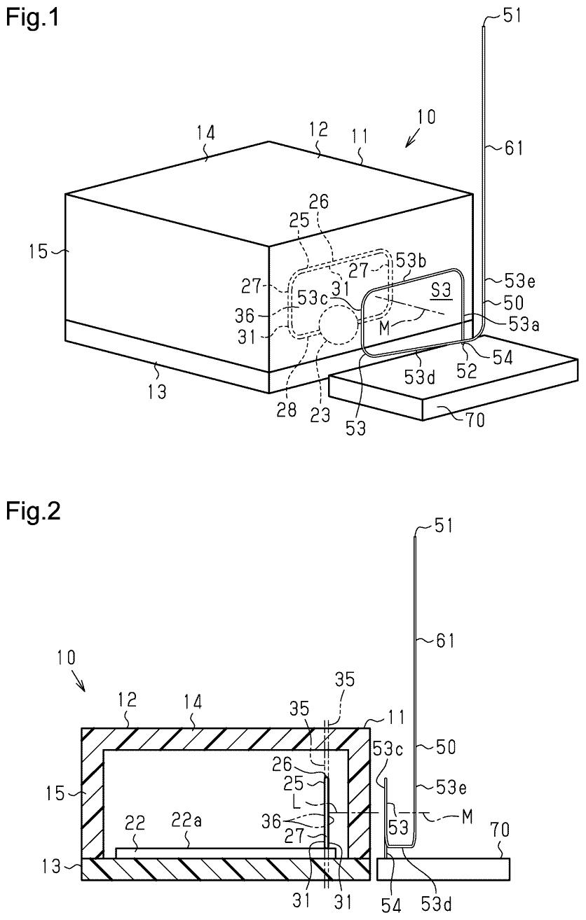

As shown in FIGS. 1 to 3, a transmitter 10 includes a housing 11, a substrate 22, a power supply unit 23, and a loop antenna 25. The transmitter 10 is configured to transmit data. Since the power supply unit 23 is illustrated schematically, a detailed illustration thereof is omitted in FIG. 2.

### Housing

The housing 11 accommodates the substrate 22, the power supply unit 23, and the loop antenna 25. That is, the transmitter 10 includes the loop antenna 25 in the housing 11.

The housing 11 includes a housing body 12 and a flat plate-shaped lid 13, which closes an opening of the housing body 12. The housing body 12 includes a first wall 14 and a second wall 15. The first wall 14 has the shape of a flat plate. The second wall 15 is a peripheral wall having a rectangular tubular shape. The second wall 15 extends from a peripheral edge of the first wall 14. The housing body 12 and the lid 13 are fixed to each other. By this fixing, the housing 11 has a sealed structure. The sealed structure prevents moisture, gas, and the like from entering the inside of the housing 11 from the outside. Therefore, the housing 11 has high environmental resistance. The housing 11 may have a sealed structure by filling the interior of the housing body 12 with resin. In this case, the housing 11 does not necessarily need to include the lid 13. External connection terminals for electrical connection or signal connection are not provided on the surface of the housing 11. For this reason, the housing 11 has a structure in which connection from the outside to the substrate 22 or the power supply unit 23 inside the housing 11 is impossible.

### Substrate

The substrate 22 includes a plate surface 22a. The power supply unit 23 and a temperature sensor (not shown) are mounted on the plate surface 22a of the substrate 22. The power supply unit 23 is an electronic component including a transmission circuit and a controller (neither is shown). The power supply unit 23 modulates a signal detected by the temperature sensor into a radio signal, and then outputs transmission power corresponding to an operating frequency to the loop antenna 25. The operating frequency band may be an LF band, an MF band, an HF band, a VHF band, a UHF band, and a 2.4 GHz band.

### Loop Antenna

The loop antenna 25, which is a transmission antenna, is manufactured by bending a metal wire, which is an example of a conductor. The loop antenna 25 includes a base portion 26, two extended portions 27, and two terminal connecting portions 28. In order to reduce the size and weight of the transmitter 10, the loop antenna 25 is reduced in size as much as possible.

Each of the two extended portions 27 protrudes from each end of the base portion 26 toward the substrate 22. The two terminal connecting portions 28 respectively protrude from ends of the extended portions 27 located on a side opposite to the base portion 26 so as to approach each other. Although not illustrated in detail, the terminal connecting portions 28 of the loop antenna 25 are electrically connected to the power supply unit 23. The loop antenna 25 is supplied with power from the power supply unit 23.

The loop antenna 25 is housed in the housing 11 such that the base portion 26 is close to the bottom of the housing body 12 and the extended portions 27 protrude from the opposite ends of the base portion 26 toward the substrate 22.

The loop antenna 25 and the substrate 22 define an opening region S2. The opening region S2 is surrounded by the loop antenna 25. The opening region S2 opens to an imaginary plane 35 extending along the metal wire. The imaginary plane 35 is a plane obtained by imaginarily extending the end edge 31 extending along the metal wire so as to surround the opening region S2. The loop antenna 25 includes an opening plane 36 in a section surrounded by the loop antenna 25. The opening plane 36 is orthogonal to the plate surface 22a of the substrate 22. A straight line orthogonal to the opening plane 36 is defined as a perpendicular L. The loop antenna 25 may be disposed on the substrate 22 such that the opening plane 36 is oblique with respect to the plate surface 22a.

### Parasitic Element

A parasitic element 50 is disposed to be located outside the housing 11. The parasitic element 50 is not in contact with the transmitter 10. The parasitic element 50 is disposed to be close to the second wall 15 of the housing 11. The parasitic element 50 faces the loop antenna 25 with the second wall 15 interposed therebetween. The parasitic element 50 is located close to the loop antenna 25 to be electromagnetically coupled to the loop antenna 25. Being “electromagnetically coupled” refers to a state in which an induced current can be caused to flow through the parasitic element 50 by a magnetic field generated by the loop antenna 25. In order to generate more induced current in the parasitic element 50 by the magnetic field generated by the loop antenna 25, it is preferable for the parasitic element 50 to be as close as possible to the loop antenna 25.

The parasitic element 50 is made of a metal wire that is an example of a conductor. The parasitic element 50 includes a first end 51 and a second end 52. The first end 51 of the parasitic element 50 is one end of the metal wire, and the second end 52 of the parasitic element 50 is the other end of the metal wire. The second end 52 is electrically connected to a ground substrate 70, which is a ground. The ground substrate 70 has the shape of a rectangular plate. The ground substrate 70 is made of a conductor. The first end 51 of the parasitic element 50 is an open end.

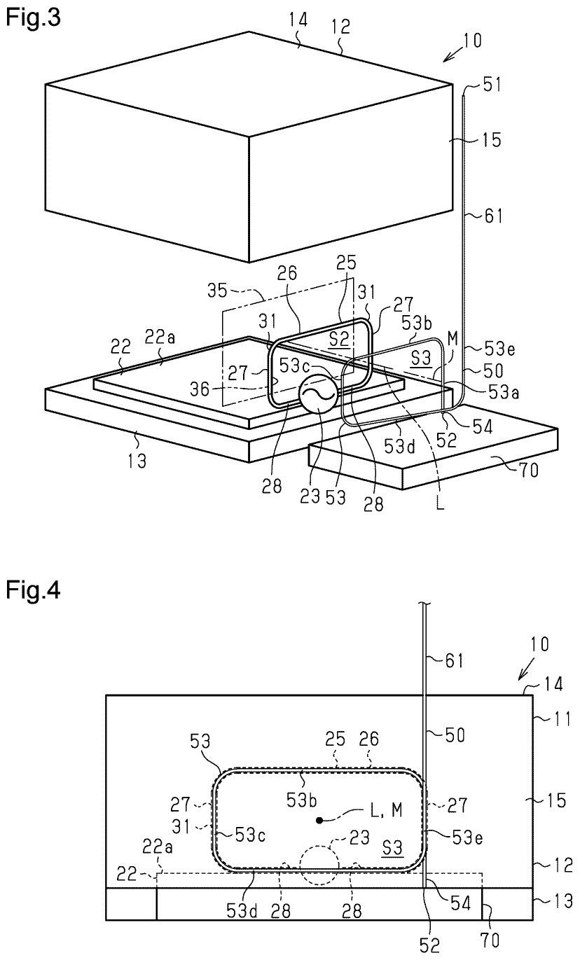

As shown in FIGS. 3 and 4, the parasitic element 50 includes a loop portion 53 and an extended section 61. The parasitic element 50 may include a connecting portion 54. The parasitic element 50 is formed by bending a metal wire.

### Connecting Portion

The connecting portion 54 is a portion extending from the loop portion 53. The connecting portion 54 extends in the vertical direction. The second end 52 is a tip of the connecting portion 54. The connecting portion 54 connects the loop portion 53 and the ground substrate 70 to each other. The connecting portion 54 extends between the ground substrate 70 and the loop portion 53.

### Loop Portion

The loop portion 53 is part of the parasitic element 50. The loop portion 53 is a section of the parasitic element 50 that is electromagnetically coupled to the loop antenna 25. The loop portion 53 is separated from the first end 51 and the second end 52. The loop portion 53 is a portion bent into a loop shape in the entire metal wire rod. The loop portion 53 has the shape of an elongated rectangular frame when viewed in one direction. Viewing the parasitic element 50 so that the loop portion 53 looks like an elongated rectangular frame is referred to as a front view.

In a front view of the parasitic element 50, the loop portion 53 defines an elongated rectangular region S3. The loop portion 53 has an axis M. The axis M is a line passing through the center of the region S3 in a front view of the parasitic element 50. The metal wire is bent such that the loop portion 53 has an elongated rectangular frame shape in a front view of the parasitic element 50.

The loop portion 53 includes a first side section 53a, a second side section 53b, a third side section 53c, a fourth side section 53d, and a fifth side section 53e. The first side section 53a extends in the vertical direction from the connecting portion 54 in a front view of the parasitic element 50. The second side section 53b extends between the first side section 53a and the third side section 53c. The second side section 53b extends horizontally. The third side section 53c extends between the second side section 53b and the fourth side section 53d. The third side section 53c extends vertically. The fourth side section 53d extends between the third side section 53c and the fifth side section 53e. The fourth side section 53d extends horizontally. The fifth side section 53e extends vertically from the fourth side section 53d.

In a front view of the parasitic element 50, the first side section 53a and the third side section 53c are parallel to each other, and the fifth side section 53e and the third side section 53c are parallel to each other. The second side section 53b and the fourth side section 53d are parallel to each other in a front view of the parasitic element 50.

The fifth side section 53e is separated from the first side section 53a in the direction in which the axis M extends. Therefore, the fourth side section 53d extends horizontally and obliquely from the third side section 53c toward the fifth side section 53e.

### Extended Section

The extended section 61 is a section of the parasitic element 50 other than the loop portion 53 and the connecting portion 54, and extends from the loop portion 53. The extended section 61 extends straight in the vertical direction between the first end 51 and the loop portion 53. The parasitic element 50 configured as described above is disposed outside the housing 11 such that the axis M of the loop portion 53 and the perpendicular L of the loop antenna 25 are parallel to each other. Therefore, in a front view of the parasitic element 50, the loop portion 53 and the loop antenna 25 appear to overlap with each other.

### Function of Parasitic Element

When transmission power is input from the power supply unit 23 to the loop antenna 25, energy radiated from the loop antenna 25 is amplified using the parasitic element 50 and radiated as radio waves.

### Gain of Loop Antenna

In the loop antenna 25, the use of the parasitic element 50 increases a gain Ga [dBi] as compared to a case in which the loop antenna 25 is used alone. The gain Ga obtained when both the loop antenna 25 and the parasitic element 50 are used is referred to as a gain Ga of the loop antenna 25. The gain Ga [dBi] represents the sensitivity in the maximum sensitivity direction as a multiple of the sensitivity of an omnidirectional antenna, which has equal sensitivity in all directions.

While the gain Ga of the loop antenna 25 alone is about −12 [dBi], the gain Ga of the loop antenna 25 is improved to about 3 to 5 [dBi]. Therefore, the improvement, which is the difference from the case of the loop antenna 25 alone, is about 15 to 17 [dB].

### Length of Parasitic Element

The wavelength at the operating frequency of the loop antenna 25 is represented by λ.

In order to increase the gain Ga of the loop antenna 25, the radio wave from the loop antenna 25 is caused to resonate with the extended section 61. In order to cause the extended section 61 to resonate, the length of the extended section 61 is preferably set to 0.10λ to 0.40λ.

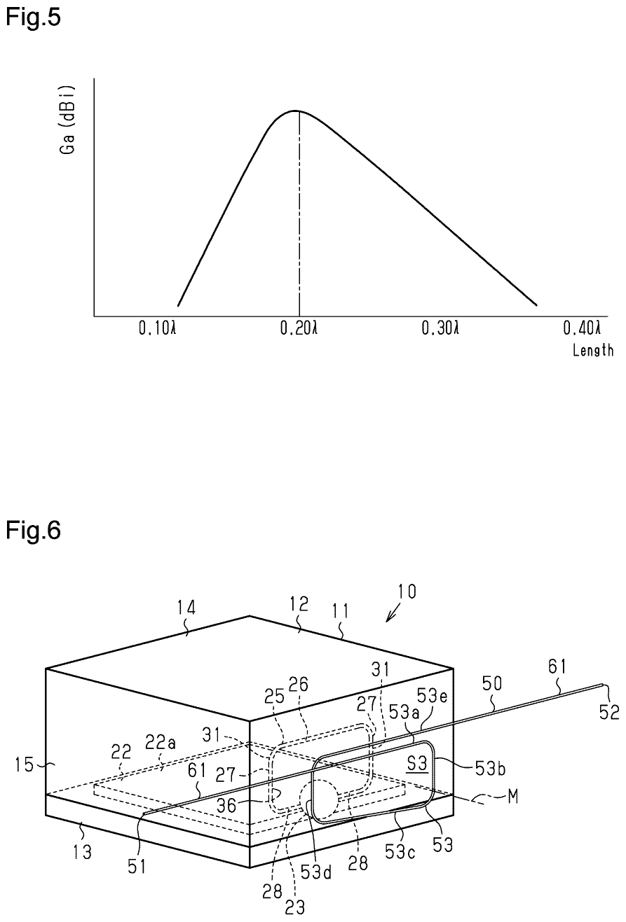

As shown in FIG. 5, it is particularly preferable that the length of the extended section 61 is about 0.20λ because the gain Ga is maximized. In consideration of resonance characteristics, the ideal length of the extended section 61 is 0.25λ. However, the length of the extended section 61 is slightly shorter than 0.25λ. This is because the induction of the loop portion 53 displaces its phase, so that the length of the extended section 61 becomes shorter than 0.25λ. Therefore, in the present embodiment, it is particularly preferable that the length of the extended section 61 is 0.20λ, which is slightly shorter than 0.25λ. If the length of the extended section 61 is shorter than 0.10λ or longer than 0.40λ, the gain Ga is significantly reduced, which is not preferable.

### Position of Parasitic Element

In order to strengthen the coupling with the magnetic field of the loop antenna 25, the parasitic element 50 is preferably as close to the loop antenna 25 as possible. As described above, an induced current flows through the loop portion 53 under the influence of the magnetic field generated by the loop antenna 25. To enhance the generation of induced current, it is desirable for the magnetic field, generated by the loop antenna 25, to have a strong influence on the loop portion 53. For this reason, it is preferable to bring the loop portion 53 as close as possible to the loop antenna 25 along the axis M. However, the distance between the parasitic element 50 and the loop antenna 25 may be changed in accordance with the operating frequency and the surrounding environment.

### Operation

Operation of the present embodiment will now be described.

When transmission power is supplied to the loop antenna 25 and a current flows through the loop antenna 25, a magnetic field and an electric field are generated around the loop antenna 25, and energy is radiated from the loop antenna 25. Outside the housing 11, an induced current flows through the loop portion 53, which is coupled to the magnetic field of the loop antenna 25. As a result of a potential difference occurring between the vicinity of the first end 51 and the other portions in the extended section 61, an electric field is generated in the extended section 61. The energy received from the loop antenna 25 is efficiently radiated as radio waves by using the extended section 61.

The first embodiment has the following advantages.

(1-1) A parasitic element 50 having only the extended section 61 without the loop portion 53 is used as a comparative example. As compared with the comparative example, the parasitic element 50 including the loop portion 53 is strongly affected by the magnetic field of the loop antenna 25. Thus, an induced current larger than that in the comparative example flows through the loop portion 53. The energy received from the loop antenna 25 is efficiently radiated by using the extended section 61. This increases the transmission output from the transmitter 10 as compared with a case in which energy is radiated as radio waves from the loop antenna 25 alone. If the amount of power fed to the loop antenna 25 is the same, the communication distance from the transmitter 10 can be extended.

The transmitter 10 is an existing transmitter that can also be used as a transmitter of a tire condition monitoring apparatus. The housing 11 of the transmitter 10 has a sealed structure, and the housing 11 and the loop antenna 25 are reduced in size. When a transmitter that can be used as a transmitter for a tire condition monitoring apparatus is used alone as the transmitter 10 for the road surface temperature measuring system, that transmitter may not have sufficient transmission output. In this case, by simply disposing the parasitic element 50 outside the housing 11, the transmission output of the transmitter 10 can be increased without changing hardware including the loop antenna 25 and without adding a device requiring a power supply.

(1-2) The parasitic element 50 includes one extended section 61 having the first end 51 as an open end. The second end 52 of the parasitic element 50 is connected to the ground substrate 70. When the transmission output is set to be the same, the length of the parasitic element 50 can be shortened as compared to a case in which the parasitic element 50 has two extended sections 61.

(1-3) The length of the extended section 61 is set to 0.10λ to 0.40λ. Since the length of the extended section 61 is defined, the radio wave from the loop antenna 25 and the extended section 61 are readily resonated. For this reason, it is possible to increase the gain Ga by the loop antenna 25 using the parasitic element 50 compared to the case of the loop antenna 25 alone.

(1-4) The parasitic element 50 includes one extended section 61, which has the first end 51 as an open end, and is not electrically connected to the power supply unit 23. When compared to directly electrically connecting the parasitic element 50 with such an open end to the transmitter 10, the impact on the transmission circuit due to lightning strikes or static electricity on the loop antenna 25 is reduced.

### Second Embodiment

A parasitic element according to a second embodiment will be described. The main difference of the second embodiment from the first embodiment is the number and shape of the extended sections. This point will be described below, and a detailed description of the same configuration as that of the first embodiment will be omitted.

### Entire Parasitic Element

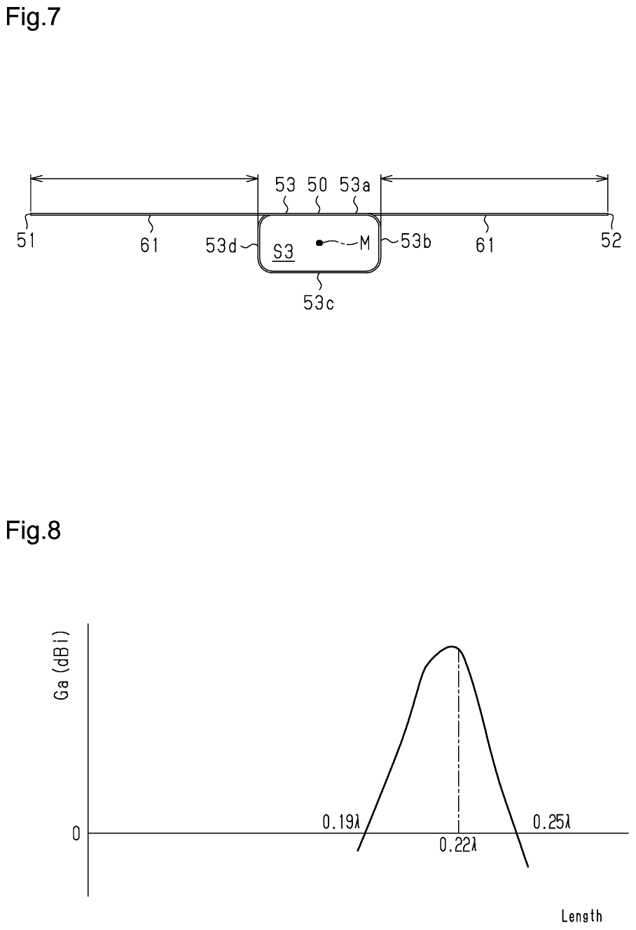

As shown in FIGS. 6 and 7, the parasitic element 50 includes two extended sections 61 so as to have two open ends on the opposite sides of the loop portion 53. The two extended sections 61 extend in opposite directions from the loop portion 53 so as to be located on the opposite sides of the loop portion 53. One of the extended sections 61 has a first end 51 at the tip, and the other extended section 61 has a second end 52 at the tip. The two extended sections 61 are linear.

One of the extended sections 61 extends between the first end 51 and the loop portion 53. The other extended section 61 extends between the second end 52 and the loop portion 53. The two extended sections 61 have the same length. The loop portion 53 is located between the two extended sections 61.

### Loop Portion

The loop portion 53 includes a first side section 53a, a second side section 53b, a third side section 53c, a fourth side section 53d, and a fifth side section 53e. The first side section 53a is located between the two extended sections 61 in a front view of the parasitic element 50. The first side section 53a extends horizontally. One of the extended sections 61 extends from the first side section 53a. The first side section 53a and one of the extended sections 61 extend linearly.

The second side section 53b extends between the first side section 53a and the third side section 53c. The second side section 53b extends vertically. The third side section 53c extends between the second side section 53b and the fourth side section 53d. The third side section 53c extends horizontally. The fourth side section 53d extends between the third side section 53c and the fifth side section 53e. The fourth side section 53d extends vertically.

The fifth side section 53e extends horizontally from the fourth side section 53d. The other extended section 61 extends from the fifth side section 53e. The fifth side section 53e and the other extended section 61 extend linearly. In a front view of the parasitic element 50, one of the extended sections 61, the first side section 53a of the loop portion 53, and the other extended section 61 are arranged in a straight line.

The first side section 53a and the third side section 53c are parallel to each other in a front view of the parasitic element 50. The second side section 53b the fourth side section 53d are parallel to each other in a front view of the parasitic element 50.

The first side section 53a and the fifth side section 53e face the base portion 26 of the loop antenna 25 with the second wall 15 interposed therebetween. The second side section 53b faces one of the extended portions 27 with the second wall 15 interposed therebetween, and the fourth side section 53d faces the other extended portion 27 with the second wall 15 interposed therebetween. The third side section 53c faces the two terminal connecting portions 28 of the loop antenna 25 with the second wall 15 interposed therebetween. The size of the rectangular frame of the loop portion 53 in a front view of the parasitic element 50 is substantially the same as the size of the rectangular frame of the loop antenna 25.

The parasitic element 50 configured as described above is disposed such that the axis M of the loop portion 53 and the perpendicular L of the loop antenna 25 are parallel to each other.

### Extended Section

The length from the loop portion 53 to each end 51, 52 is the length of each extended section 61. In order to increase the gain Ga of the loop antenna 25, the radio wave from the loop antenna 25 is caused to resonate with the extended section 61.

As shown in FIG. 8, in order to cause the extended sections 61 to resonate, the length of the extended sections 61 is preferably set to 0.19λ to 0.25λ. In the parasitic element 50, the sum of the lengths of the two extended sections 61 is preferably 0.38λ to 0.50λ.

When the length of each extended section 61 is about 0.22λ, the gain Ga is maximized, which is particularly preferable. If the length of the extended section 61 is less than 0.19λ or more than 0.25λ, the gain Ga is extremely low, which is not preferable.

The second embodiment achieves the following advantages in addition to the advantage described in (1-1) of the first embodiment.

(2-1) The length of each extended section 61 is set to 0.19λ to 0.25λ. This allows the extended sections 61 to readily resonate with the radio wave from the loop antenna 25. Thus, it is possible to increase the gain Ga by the loop antenna 25 using the parasitic element 50 compared to the case of the loop antenna 25 alone.

(2-2) The parasitic element 50 includes the extended section 61 having the first end 51 as an open end and the extended section 61 having the second end 52 as an open end. Compared to directly electrically connecting the parasitic element 50 with such an open end to the transmitter 10, the impact on the transmission circuit due to lightning strikes or static electricity on the loop antenna 25 is reduced.

The above-described embodiments may be modified as follows. The embodiments and the following modifications can be combined as long as the combined modifications remain technically consistent with each other.

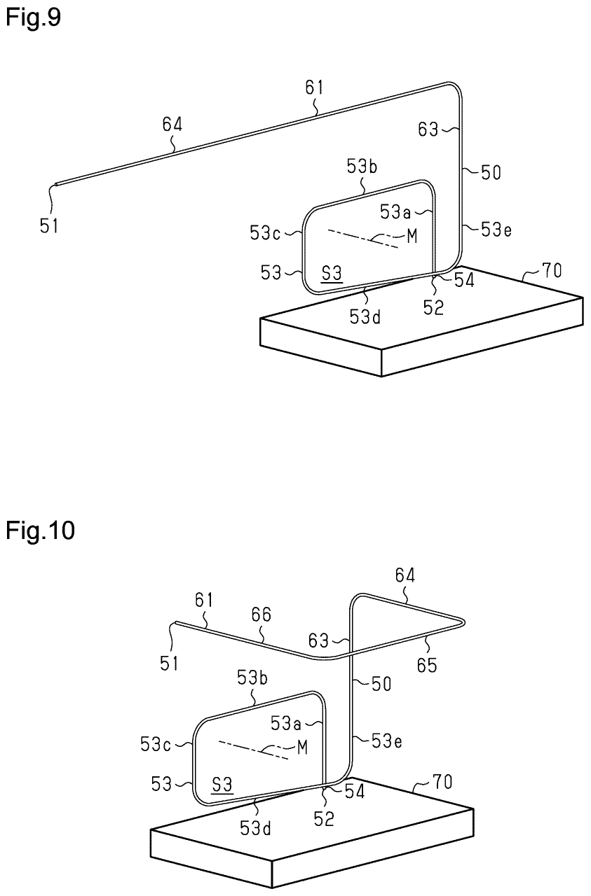

As shown in FIG. 9, in the first embodiment, the extended section 61 may be bent so as to include a first linear section 63 and a second linear section 64. The first linear section 63 extends between the loop portion 53 and the second linear section 64 in a front view of the parasitic element 50. The first linear section 63 extends vertically. The first linear section 63 extends between the fifth side section 53e of the loop portion 53 and the second linear section 64.

The second linear section 64 extends straight from the first linear section 63. The second linear section 64 extends horizontally. The first end 51 is the tip of the second linear section 64. The extended section 61 thus has the first end 51 as an open end. The parasitic element 50 includes one extended section 61 so as to have one open end.

In this case, the lengths of the first linear section 63 and the second linear section 64 may be different from each other. Unlike the first embodiment, the extended section 61 is bent, so that the resonance characteristic is slightly deviated from the operating frequency, and the gain Ga is changed. However, the parasitic element 50 is reduced in size as compared with the case in which the extended section 61 is linear.

The shapes of the extended sections 61 are not limited to those disclosed in the first embodiment and the second embodiment, but may be changed to other shapes such as a zigzag shape called a meander line or a spiral shape. In addition, the shapes of the extended sections 61 may be changed according to the space around the transmitter 10 or the arrangement of articles around the transmitter 10. Further, the shapes of the extended sections 61 may be changed so as to conform to the surface of the housing 11 of the transmitter 10.

As shown in FIG. 10, the extended section 61 may include a first linear section 63, a second linear section 64, a third linear section 65, and a fourth linear section 66. The first linear section 63 extends between the loop portion 53 and the second linear section 64 in a front view of the parasitic element 50. The first linear section 63 extends vertically. The first linear section 63 extends between the fifth side section 53e of the loop portion 53 and the second linear section 64.

The second linear section 64 extends between the first linear section 63 and the third linear section 65. The second linear section 64 extends horizontally. The third linear section 65 extends between the second linear section 64 and the fourth linear section 66. The third linear section 65 extends horizontally. The fourth linear section 66 extends from the third linear section 65. The fourth linear section 66 extends horizontally.

The second linear section 64 and the fourth linear section 66 are parallel to each other. The first end 51 is the tip of the fourth linear section 66. The extended section 61 thus has the first end 51 as an open end. The parasitic element 50 includes one extended section 61 so as to have one open end.

In the present embodiment, in order to reduce the size of the extended section 61, the extended section 61 is bent so as to have the first linear section 63, the second linear section 64, the third linear section 65, and the fourth linear section 66. When bending the extended section 61, it is preferable to adjust the length of each of the linear sections 63 to 66 so that the gain Ga does not decrease.

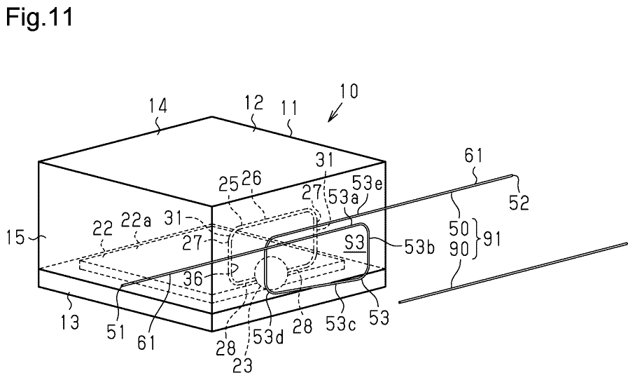

As shown in FIG. 11, a parasitic element 91 may include the parasitic element 50 of the second embodiment and the linear element 90. The linear element 90 is made of a metal wire. The linear element 90 extends linearly. The linear element 90 is arranged side by side with the two extended sections 61 of the parasitic element 50 in a direction in which the axis M extends so as to be parallel to each of the two extended sections 61 of the parasitic element 50.

In order to increase the improvement [dB], the length of the linear element 90 is preferably about 0.50λ, and particularly preferably slightly shorter than 0.50λ. The linear element 90 is arranged in parallel with the opening plane 36 of the loop antenna 25. The linear element 90 is preferably disposed at a position away from the loop antenna 25 by about 0.10λ.

This configuration allows the linear element 90 to function as a director that extracts energy radiated from the parasitic element 50. Therefore, in the parasitic element 91 including the linear element 90, the directivity of the radio wave radiated from the parasitic element 50 close to the loop antenna 25 is enhanced by the linear element 90. As a result, the gain Ga by the loop antenna 25 using the parasitic element 91 is increased as compared with the case of the loop antenna 25 alone.

The linear element 90 does not necessarily need to be parallel to each of the two extended sections 61 of the parasitic element 50, but may be slightly inclined. The linear element 90 may be formed by a metal product made of a metal wire or a metal plate, or may be formed by a conductor trace provided on a printed circuit board or a flexible substrate. Alternatively, the linear element 90 may be formed of a lead including a single wire and a stranded wire, or may be formed of a conductive plastic or a conductive rubber material.

The parasitic element 91 may include the parasitic element 50 of the first embodiment and the linear element 90. In this case, the linear element 90 is arranged to extend vertically so as to be parallel to the extended section 61 of the parasitic element 50.

The parasitic element 91 may include the parasitic element 50 shown in FIG. 9 and the linear element 90. In this case, the linear element 90 is preferably arranged side by side with the extended section 61 so as to be parallel to the second linear section 64 of the extended section 61.

The size of the rectangular frame of the loop portion 53 may be smaller or larger than the size of the rectangular frame of the loop antenna 25. That is, in a front view of the parasitic element 50, the loop portion 53 and the loop antenna 25 do not necessarily need to overlap with each other.

Alternatively, at least one of the first side section 53a to the fifth side section 53e of the loop portion 53 may overlap with the loop antenna 25.

Although the loop antenna 25 and the parasitic element 50 are formed of a metal wire, which is a conductor, the present disclosure is not limited thereto. The materials of the loop antenna 25 and the parasitic element 50 are not limited as long as they are conductors. The loop antenna 25 and the parasitic element 50 may each be formed by a metal product made of a metal wire or a metal plate, or may be formed by a conductor trace provided on a printed circuit board or a flexible substrate. Alternatively, the loop antenna 25 and the parasitic element 50 may each be formed of a lead including a single wire and a stranded wire, or may be formed of a conductive plastic or a conductive rubber material. Furthermore, the loop antenna 25 and the parasitic element 50 may be formed by plating on the housing 11 made of plastic or ceramic or by a trace made of conductive paint.

The electronic component provided on the substrate 22 of the transmitter 10 may be any electronic component such as a pressure sensor.

The transmitter 10 may be used as a transmitter of a system other than the road surface temperature measuring system.

The loop antenna 25 may be manufactured by bending a single rectangular leaf spring. In this case, the loop antenna 25 is made of stainless steel, which is an example of a conductor. Also in this case, the loop antenna 25 includes a base portion 26, two extended portions 27, and two terminal connecting portions 28. Each of the base portion 26, the extended portions 27, and the terminal connecting portions 28 has the shape of an elongated plate.

### REFERENCE SIGNS LIST

10: Transmitter, 11: Housing, 25: Loop Antenna, 50, 91: Parasitic Element, 51: First End as Open End, 52: Second End as Open End, 53: Loop Portion, 61: Extended Section, 90: Linear Element

1. A parasitic element for use in a transmitter configured to transmit data, wherein
the transmitter includes a loop antenna to which power is supplied and a housing that accommodates the loop antenna,
the parasitic element is disposed to be located outside the housing and includes:
a loop portion that is a part of the parasitic element; and
one extended section that is a part other than the loop portion and extends from the loop portion,
the loop portion is configured to be electromagnetically coupled to the loop antenna, the parasitic element includes a first end that is an open end and a second end configured to be connected to a ground,
the extended section includes the first end of the parasitic element, and
the extended section has a length of 0.20λ, where λ is a wavelength at an operating frequency of the loop antenna.

2. (canceled)

3. (canceled)

4. (canceled)

5. A parasitic element for use in a transmitter configured to transmit data, wherein
the transmitter includes a loop antenna to which power is supplied and a housing that accommodates the loop antenna,
the parasitic element is disposed to be located outside the housing and includes:
a loop portion that is a part of the parasitic element; and
two extended sections located on opposite sides of the loop portion, each of the two extended sections being a part other than the loop portion and extending from the loop portion,
the loop portion is configured to be electromagnetically coupled to the loop antenna,
each of the two extended sections includes one of ends of the parasitic element as an open end, and
the two extended sections each have a length of 0.22λ, where λ is a wavelength at an operating frequency of the loop antenna.

6. The parasitic element according to claim 1, further comprising a linear element arranged side by side with the extended section.

7. The parasitic element according to claim 5, further comprising a linear element arranged side by side with the two extended sections.
